(19) United States
(12) Patent Application Publication
(10) Pub. No.: US 2024/0383562 A1
(43) Pub. Date: Nov. 21, 2024

(54) ADJUSTABLE AIR PRESSURE CHAMBER

(71) Applicant: Eko Sport, Inc., Grand Junction, CO (US)

(72) Inventor: Darek C. Barefoot, Grand Junction, CO (US)

(21) Appl. No.: 18/664,440

(22) Filed: May 15, 2024

Related U.S. Application Data
(60) Provisional application No. 63/467,727, filed on May 19, 2023.

(51) Int. Cl. B62K 25/06; B62K 25/04

(52) U.S. Cl. CPC B62K 25/06; B62K 2025/048

(57) ABSTRACT

A suspension system for a fork includes a first tube and a second tube that telescopically interfit with one another. A damping system is in one leg of the fork. The damping system includes an air chamber having a first portion and a second portion separated by a check valve. A Schrader valve permits the addition and removal of air from the air chamber. Actuation of the Schrader valve actuates the check valve and allows air to flow into both the first portion and second portion simultaneously. The air volume in the air chamber is sufficient to allow a standard pump pressure gauge to read the pressure in the air chamber.

### BACKGROUND OF THE INVENTION

The present disclosure relates generally to suspension components on vehicles. More particularly, the present disclosure relates to a suspension that allows a user to adjust the air pressure in an air chamber, which both affects the damping characteristics and improves resistance to cavitation.

Many suspensions for two wheeled vehicles include a front fork. The front fork often has one leg that functions as a spring and governs the bulk of the compression and rebound of the front fork when the front wheel encounters an obstacle. The other leg is frequently a damper that smooths the compression and rebound characteristics of the spring. Often the damper applies additional resistance to minimize shocks at top out, bottom out or both.

Frequently, the damping medium in the damper is oil, hydraulic fluid, or another liquid. Among the reasons that a liquid is selected for a damping medium is that it is substantially incompressible, and therefore provides a consistent damping profile. However, because liquids are incompressible, additional structures must be included in the damping system for it to function properly.

On a compression stroke, a piston and shaft move further into the damping chamber. The entry of a greater portion of the shaft then takes up more space in the damping chamber than was taken up by the piston alone. This additional volume must be accounted for within the damping system. Because the damping fluid is substantially incompressible, it is conventional to include an air chamber separated from the damping fluid that compensates for the presence and absence of the shaft. This air chamber is frequently referred to as a “compensator chamber” because of its purpose.

In conventional designs, a floating piston may be incorporated into one end of the damper structure. One side of the floating piston may form one side of the damper chamber. The opposite side of the floating piston may form one side of an air chamber containing an optional coil spring. This air chamber functions as the compensator chamber. The chamber may function as a compensator because as the substantially incompressible fluid presses against the floating piston, the coil spring and the air are able to compress, thereby increasing the effective volume of the damper chamber. Similarly, on a rebound stroke, as the pressure of the substantially incompressible fluid decreases, the floating piston may move under the force of the air and coil spring to increase the size of the compensator chamber and decrease the effective volume of the damper chamber. However, the conventional structure has at least one drawback. The conventional design does not allow the user to adjust usefully the compensating force acting on the floating piston, which has an influence on the performance of the suspension fork under various conditions. Accordingly, riders have had to tolerate poor riding conditions because of this drawback.

### SUMMARY OF THE INVENTION

The present design incorporates features that may serve to allow for increased riding comfort and increased adjustability by a rider of the pressure within the compensator chamber. Further, the present design may allow for the rider to increase or decrease the progressivity of the fork's effective spring rate. Further, the present design may incorporate structures that allow for adjustability within a configuration that is generally the same as the existing overall configurations to allow for the addition of rider comfort without adding a great deal of size or weight to the suspension package. Finally, the present design may allow for a rider to adjust the flow rate of the substantially incompressible damping fluid while also allowing for an adjustment of the compensator air pressure.

It is therefore desirable for a shock absorber that includes an air chamber that is large enough to allow a user to determine the pressure of air within the air chamber, as by means of a conventional pump with pressure gauge, while being small enough to properly affect the suspension characteristics. It is further desirable that the air chamber be divided into a first chamber that allows for the size to be appropriate for the gauge and a second chamber that allows for the size to be appropriate to compensate for the entry of the damper shaft. It is further desirable for the suspension to be adjustable by a typical end user.

In a first embodiment, a suspension for a vehicle may include a compensator assembly and an air introduction system. The compensator assembly may be attached to a fork leg, and may comprise a compensator shaft and a floating piston. The compensator shaft may be attached to an end of the leg and may have a free end. The floating piston may substantially surround the compensator shaft and may be positioned between the fixed piston and the end of the leg. The floating piston may define a boundary of an air chamber.

The air introduction system may include a first valve and a second valve. The first valve may extend between an exterior of the fork leg and the interior of the air chamber. The second valve may divide the air chamber into a first air chamber and a second air chamber.

The first air chamber may have a first volume. The second air chamber may have a second volume. The first volume may be larger than the second volume. The first volume may be at least twice as large as the second volume.

Opening the first valve may open the second valve. A rotatable adjuster may be attached to the compensator shaft. The second valve may open without opening the first valve. A fixed piston may be attached adjacent to the free end of the compensator shaft.

In another embodiment, a suspension for a vehicle may include an air chamber, a check valve, and an air pressure change structure. The air chamber may be defined at least in part by a floating piston, a tube and a cap.

The check valve may divide the air chamber into a first portion and a second portion. When the check valve is closed, air in the second portion may be substantially prevented from flowing through the check valve to the first portion. The air pressure change structure may include a Schrader valve configured to allow the attachment of a pump capable of changing the air pressure in the air chamber by changing the amount of gas present within the air chamber.

A volume of the first portion may be larger than a volume of the second portion. The combined volume of the first portion and the second portion may be configured to enable a pressure gauge on the pump to accurately read the air pressure in the air chamber when the pump is attached to the Schrader valve. The volume of the second portion may be variable. Actuation of the Schrader valve may actuate the check valve.

Actuation of the check valve may allow air to pass between the first portion and the second portion. The check valve may be actuated when air pressure in the first portion exceeds air pressure in the second portion enough to exceed a spring force on the check valve. The volume of the first portion may be substantially fixed. An auxiliary passageway remote from the check valve may allow air to pass between the first portion and the second portion.

In another embodiment, a suspension for a vehicle may include a first leg and a second leg. The second leg may include a liquid chamber, a first air chamber, a second air chamber, a floating piston, and an air pressure adjuster.

The floating piston may be between the liquid chamber and the second air chamber and may separate the liquid chamber from the second air chamber. A pressure from liquid in the liquid chamber may be capable of moving the floating piston into the second air chamber, thereby substantially equalizing the pressure of the liquid and the air pressure in the second air chamber. The air pressure adjuster may be capable of adjusting the pressure in the first air chamber and the second air chamber. The air pressure adjuster may include a finger that dislodges a stopper, thereby allowing air to enter the first air chamber and the second air chamber simultaneously.

The suspension may further include a rotatable adjuster for adjusting a flow characteristic of the liquid in the liquid chamber. The air pressure adjuster may be attached to the rotatable adjuster. The air pressure adjuster may include a Schrader valve. The Schrader valve may be capable of allowing air to pass from outside of the second leg into the inside of the first air chamber and capable of allowing air to pass from the inside of the first air chamber to the outside of the second leg. The suspension may further include a damper piston within the liquid chamber attached to a shaft that extends through the second air chamber. The shaft may be attached to a rotating adjuster. The floating piston may substantially surround the shaft.

### BRIEF DESCRIPTION OF DRAWINGS

FIG. 1 is a perspective view of a bicycle showing the general configuration and position of a shock absorber according to the disclosed embodiments;

FIG. 2 is an exterior front view of a front fork of a bicycle according to one embodiment;

FIG. 3 is a side view of the front fork of FIG. 1;

FIG. 4 is a partial cross-sectional view of the front fork of FIG. 1 taken along line 4-4 of FIG. 3;

FIG. 5 is a close view of the cross-section of FIG. 4 showing the design within the area 5 demarcated by the dashed line in FIG. 4;

FIG. 6 is a close view of the cross-section of FIG. 5 showing the design within the area 6 demarcated by the dashed line in FIG. 5;

FIG. 7 is a close view of the cross-section of FIG. 5 showing an alternative design within the area 6 demarcated by the dashed line in FIG. 5;

FIG. 8 is a close and partially exploded view of the top of the front fork of FIG. 2 showing the design within the area 8 demarcated by the dashed line in FIG. 2;

FIG. 9 is a partial perspective view of the front fork attached to a conventional manual pump;

FIG. 10 is a close view similar to FIG. 5, but showing an alternative embodiment of the design within the area 5 demarcated by the dashed line in FIG. 4; and

FIG. 11 is a close view similar to FIG. 5, but showing another alternative embodiment of the design within the area 5 demarcated by the dashed line in FIG. 4.

In describing the preferred embodiment of the invention, which is illustrated in the drawings, specific terminology will be resorted to for the sake of clarity. However, it is not intended that the invention be limited to the specific term so selected, and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

In this detailed description, various terms relating to direction may be used. The elements discussed herein relate to a bicycle. Because, in its operable position, a bicycle is oriented generally vertically, i.e., perpendicular to the ground, the direction terms refer to the position of an element relative to gravity when the bicycle is in its operable position. Accordingly, for example, the term “downwardly” refers to the direction towards the ground when the bicycle is in its operable position, and the term “forwardly” relates to a direction towards a front wheel of the bicycle when it is in its operable position. Further, the terms “inboard” and “outboard” may be used. The term “inboard” describes a position between one item and a vertical plane substantially bisecting the bicycle. The term “outboard” describes a position of an object further from the vertical center plane of the bicycle. In addition, the terms “bicycle” and “bike” are used herein interchangeably. A person having ordinary skill in the art will understand that if something is referred to as one, it can refer to the other.

In the present disclosure, the suspension structure may be described as it relates to a bicycle. However, the suspension structure described in the present embodiments may instead be applied to other vehicles. The present suspension structure may be used with vehicles having a different number of wheels, for example. The suspension structure may be used in connection with a motorized vehicle.

The structures described herein may be applied to either a front or rear suspension of a vehicle, most particularly a bicycle. The remaining structures present in the suspension may be illustrated and may be described in at least a cursory fashion. However, these structures are not critical to the use of the embodiments described herein. The present embodiments could be incorporated with other suspensions that use a compressible gas. Accordingly, the suspension system elements shown should not be construed as being limiting to the embodiments described.

In general, persons of ordinary skill in the art are familiar with the structural and functional differences and limitations between shock absorbers and can make the necessary modifications to use the structures described herein in context. However, a person of ordinary skill in the art is able to understand that any of the disclosed embodiments could, in theory, be used in another suspension system in current operation or later developed.

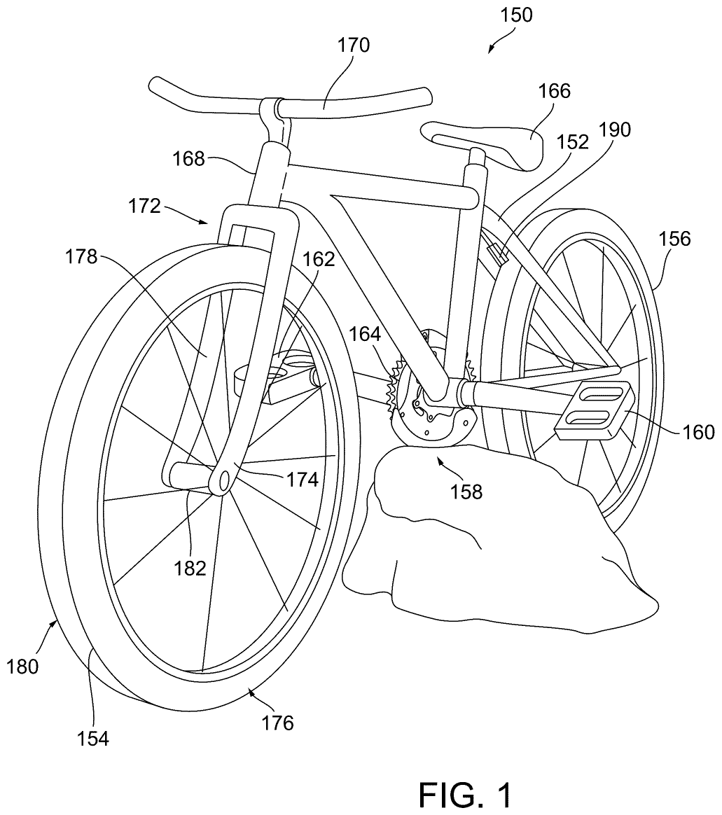

The overall configuration of the present device in the context of a vehicle is shown in FIG. 1. The present device is configured to be primarily used with a pedaled bicycle, such as the bicycle 150. The device could be used with a powered bicycle, a motorcycle, a moped, or similar vehicle. The bicycle 150 may include a frame 152, a front wheel 154, and a rear wheel 156. The bicycle 150 may further include a drive system 158 that conventionally includes a first pedal 160 and a second pedal 162 positioned generally opposite one another. When a user uses motive power, the user alternatingly presses the first pedal 160 and the second pedal 162. Each of the first pedal 160 and the second pedal 162 are conventionally attached to a front chain ring 164. A conventional chain (not shown) transmits the driving force from the pedals 160, 162, through the front chain ring 164 to a rear chain ring (not shown). The rear chain ring is secured to the rear wheel 156, causing it to rotate about an axle passing therethrough (not shown) and thereby causing the bicycle 150 to move. The bicycle frame 152 conventionally allows for the attachment of a seat 166 that a user sits on when using the pedals 160, 162. The bicycle frame 152 also conventionally includes a head 168. The head 168 allows for the attachment of handlebars 170 that further attach through the head 168 to a front fork 172. The front fork 172 conventionally has a first leg 174 that extends on one side 176 of the front wheel 154 and a second leg 178 that extends on an opposite side 180 of the front wheel 154. An axle 182 is configured to pass through a center of the front wheel 154 and an aperture in each of the first leg 174 and the second leg 178. Any conventional axle structure and attachment structure can be used with the present suspension system.

In addition to the front fork 172, the bicycle frame 152 may provide for the attachment of a rear shock, such as the rear shock 190. In general, the rear shock 190 will extend between the bicycle frame 152 and the rear wheel 156 to absorb the shock of impact to a rear wheel.

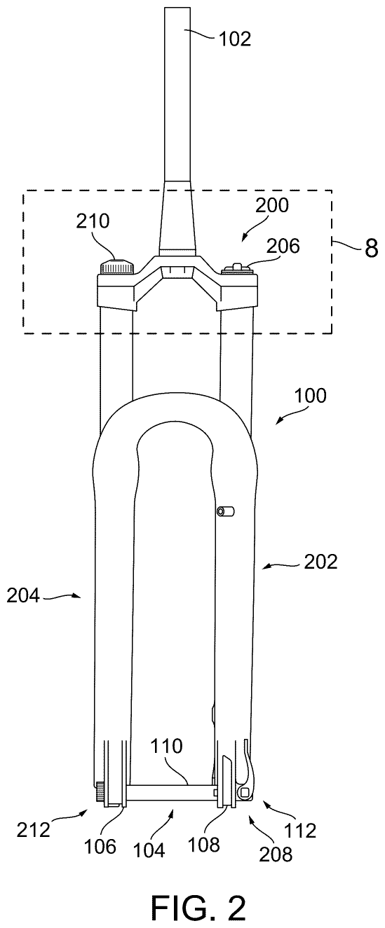

Looking to FIG. 2, the suspension system 100 may be configured to be used as the front fork 172 in the position generally illustrated in FIG. 1. As previously described, the top end 102 of the suspension system 100 may be attached to handlebars or another steering system, manipulable by a rider to set and change the direction of the vehicle. The bottom end 104 of the suspension system 100 may include a first bracket 106 and a second bracket 108 that may be configured to allow an axle 110 to be passed therethrough. The first bracket 106 and the second bracket 108 may be any conventional open bore or closed bore bracket as desired by the designer. The axle 110 shown includes a quick release 112. The use of such a quick release 112 is optional and any mechanism for fixing the axle in place may be substituted therefor. In operation, a hub and wheel (not shown) may be mounted in surrounding fashion to the axle 110 to allow the rotatable attachment of a front wheel and tire (not shown).

Looking again at FIG. 2, as is true of many conventional suspension systems, the front fork 200 may include a first leg 202 and a second leg 204. In many suspension systems, one of the legs contains a spring system that governs the overall way the suspension system contracts and expands in a suspension stroke when the front tire (not shown) encounters a bump or obstacle in riding, such as the obstacle shown in FIG. 1. In the illustrated embodiment, this spring leg may be the first leg 202. In the context of the present disclosure, the exact configuration or mechanism of the spring leg is not critical. Any conventional spring, whether an air spring or a mechanical spring or other conventional spring may be used in the first leg 202. Where it is desirable, the spring leg 202 may allow a user to adjust various characteristics of the spring through a knob or other manual adjustment mechanism either at the top 206 or the bottom 208 of the first leg 202, or both, depending on the designer's preferences. In other embodiments, no adjustment may be available. A person of ordinary skill may select any desirable spring for that first leg 202. The FIGS. present in this disclosure do not illustrate the spring leg in any detail, and the presence or absence in this disclosure or in the FIGS. of any structure that a designer might expect to be present for a particular configuration should not inform the designer of which spring to select. These details are necessary to a functioning product, but do not form part of the present disclosure. These details may be selected by a person of skill in the art without undue experimentation.

The present disclosure relates to the damper leg or second leg 204. The second leg 204 also has a top 210 and a bottom 212. An overall purpose of the second leg 204 may be to affect the compression and/or expansion rate of the spring leg 202. In particular, the damper leg 204 may apply additional resistance to the full compression and full expansion of the suspension 100, thereby damping or resisting a harsh jolt at complete compression and expansion. This allows for a superior ride feel for a typical rider. In many embodiments, one or more features of the damper leg 204 may be adjustable by a rider by an adjuster at the top 210 or bottom 212 of the second leg 204, and in some instances, in both positions. The embodiments disclosed herein are desirably placed adjacent to the top 210 of the second leg 204 and incorporate one or more adjusters adjacent the top 210, as will be described in greater detail below.

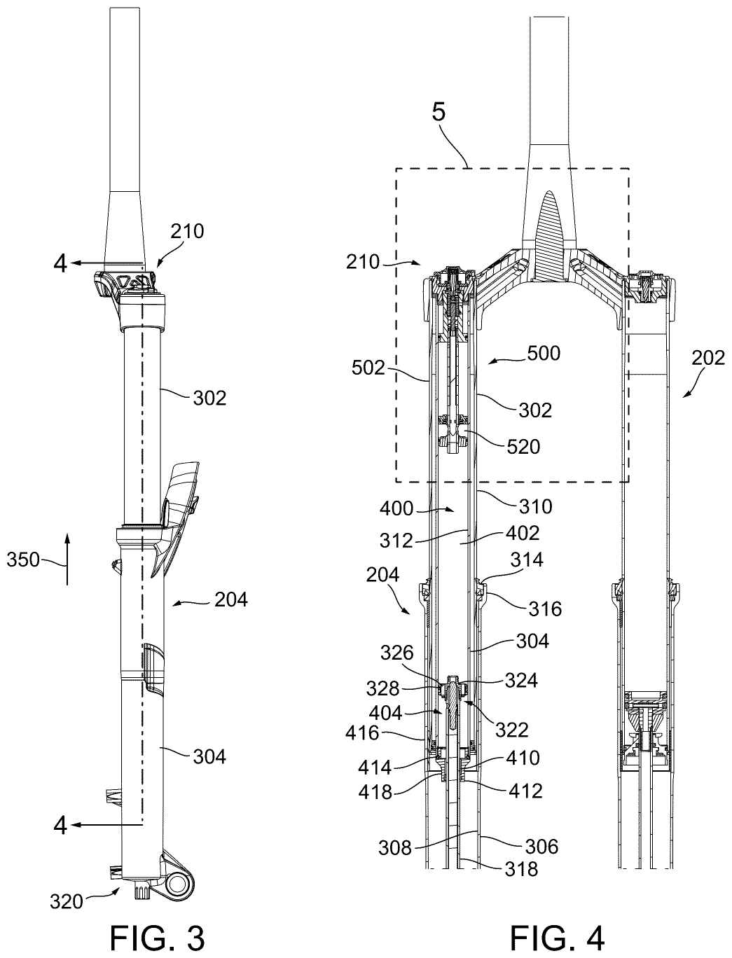

Turning to FIGS. 3-4, an overview of the structure may be seen. The second leg or tube 204 may be annular and may include an upper portion or tube 302 and a lower portion or tube 304. As is conventional, the upper portion 302 and the lower portion 304 may be concentric and may be configured to be telescopically slidable with respect to one another. The lower portion 304 may include an outer surface 306 and an inner surface 308. The upper portion 302 may include an outer surface 310 and an inner surface 312. A first seal 314 may extend from a top end 316 of the lower portion 304 and may engage the outer surface 310 of the upper portion 302. The first seal 314 may be any conventional seal or series of seals and dust wipes that a designer may typically select from. A damper shaft 318 may be attached to the bottom 320 of the lower portion 304 and may extend upwardly. A first fixed piston 324 may be attached to, at or adjacent to a free end 322 of the damper shaft 318. The first fixed piston 324 may remain substantially fixed in position relative to the lower portion 304 of the second leg 204. An outer edge 326 of the first fixed piston 324 may be attached to a second seal 328. The second seal 328 may be configured to extend between the first fixed piston 324 and the interior surface 312 of the upper portion 302. The first fixed piston 324 is thereby sealingly slidingly positioned within the upper portion 302 of the second leg 204 and is configured to reciprocate within the upper portion 302 of the second leg 204 during a suspension cycle. The first fixed piston 324 is configured to separate the chamber 400 in the annular second leg 204 into an upper chamber 402 and a lower chamber 404. In many embodiments, the first chamber 400, including the upper chamber 402 and the lower chamber 404, may be filled or substantially filled with a substantially incompressible fluid. The substantially incompressible fluid may be a liquid, and in many embodiments may be oil or other hydraulic fluid. In many embodiments, it may be desirable for the substantially incompressible fluid to also function as a lubricant to allow the parts to more easily slide relative to one another.

The first or liquid chamber 400 may be bounded by a lower seal or seal assembly 410 that is attached to the lower end 416 of the upper tube 302. The lower seal assembly 410 may be configured to retain the liquid within the liquid chamber 400 while allowing the damper shaft 318 to move into and out of the liquid chamber 400 during compression and rebound strokes of the suspension cycle. The lower seal assembly 410 may include both a first lower seal 412 that may extend between the lower fixture 418 and the shaft 318 and a second lower seal 414 that may extend between the lower fixture 418 and the upper tube 302.

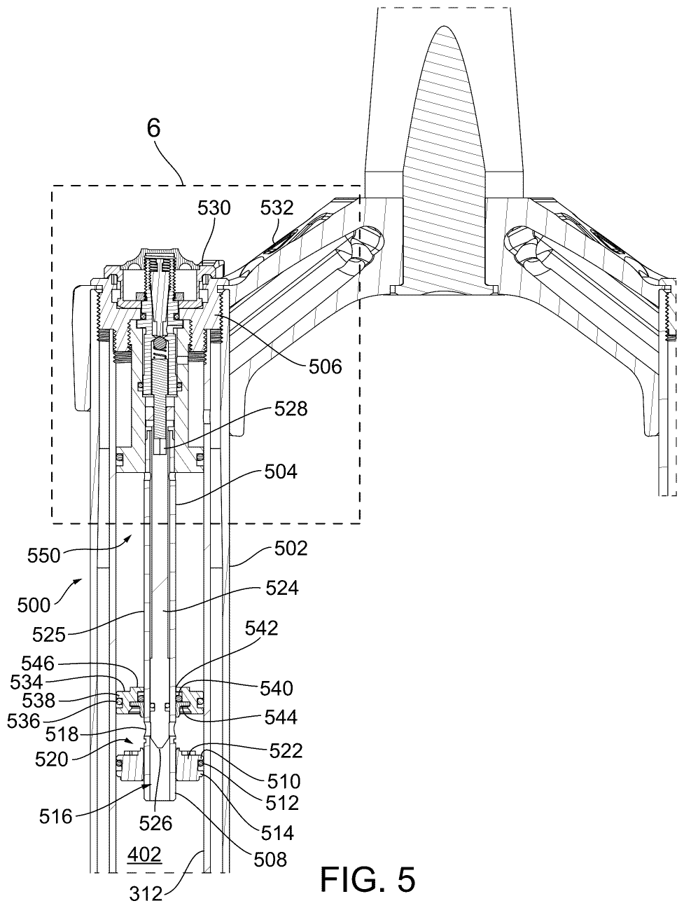

A compensator assembly 500 may be incorporated into or attached to a top portion 502 of the upper portion 302 of the second leg 204. The compensator assembly 500 is most clearly shown in FIG. 5. The compensator assembly 500 may include an annular shaft 504 attached directly or indirectly to a cap 506, which further engages the upper portion 502 of the second leg 204. As is shown in the FIGS., the compensator shaft 504 and the cap 506 may threadably engage one another and the cap 506 may threadably engage the second leg 204. The compensator shaft 504 may terminate in a free end 508. A second fixed piston 510 may be attached at or adjacent to the free end 508 of the compensator shaft 504. A third seal 512 may be attached around a periphery 514 of the second fixed piston 510 and may extend between the second fixed piston 510 and the interior surface 312 of the upper portion 302 of the second leg 204. The second fixed piston 510 may remain in a generally fixed position relative to the upper portion 302 of the second leg 204.

Looking at FIGS. 3-5 together, during a compression stroke, lower leg 304 may move toward the top end 210 of the upper leg 302 in the direction shown by the arrow 350 in FIG. 3. The first fixed piston 324 may move into the upper chamber 402. The movement of the first fixed piston 324 may force the substantially incompressible fluid in the upper chamber 402 against the second fixed piston 510. The substantially incompressible fluid may also flow through the shaft chamber 516 in the compensator shaft 504 and may flow through one or more apertures 518 in the compensator shaft 504 and into the third chamber 520 on the opposite side of the second fixed piston 510 from the upper chamber 402. On a rebound stroke, the substantially incompressible fluid may be permitted to flow in a reverse direction through the apertures 518 and compensator shaft 504 and may also be permitted to flow through a conventional valving structure 522 through the second fixed piston 510. The valving 522 is not shown in detail but well known to persons of skill in the art. In addition, valving may be incorporated into the first fixed piston 324 to allow fluid to flow between the upper chamber 402 and the lower chamber 404 during compression and rebound strokes, as is well known to persons of skill in the art.

In many embodiments, it is desirable to allow a rider to adjust or set the rate at which the substantially incompressible fluid may flow from the upper chamber 402 to the third chamber 520. In many embodiments, a pin 524 may be incorporated within the compensator shaft 504. The pin 524 may be configured to translate within the compensator shaft 504 so that a free end 526 of the pin 524 may variably occlude the apertures 518 in the compensator shaft. In many embodiments, the captured end 528 of the pin 524 may be directly or indirectly attached to a rotatable adjuster 530 that is positioned on an outside 532 of the top end 502 of the second leg 204.

The combined chambers 402, 404, and 520 together form a liquid chamber 400 having a combined volume. As may be most apparent from an examination of FIG. 4, additional adjustments to the damper structure 500 must accommodate the change in effective volume within the liquid chamber 400, caused by the introduction of the damper shaft 318 into the liquid chamber 400. That is, during the compression stroke, the combined volume in the chambers 402, 404, 520 decreases by the volume of the portion of the shaft 318 that intrudes into the lower chamber 404. Similarly, during the rebound stroke, the combined volume in the chambers 402, 404, 520 increases by the volume of the damper shaft 318 that recedes from the chamber 404. Accordingly, it may be desirable to incorporate a chamber with a variable volume in order to compensate for the volume changes in the liquid chamber 400 due to changes in the damper shaft volume due to changes in the damper shaft's position. This chamber may be generally called a compensation or compensator chamber.

Returning to FIG. 5, to form a compensator chamber within the suspension 100, a floating piston 534 may be used. The floating piston 534 may form one side of the third chamber 520 and may substantially surround the annular shaft 504. A first floating piston seal 536 may substantially surround an outer circumference 538 of the floating piston 534 and form a seal between the floating piston 534 and the inner surface 312 of the upper leg 302. A second floating piston seal 540 may be positioned on an inner circumference 542 of the floating piston 534 and may form a seal between the floating piston 534 and the outer surface 525 of the annular shaft 504. A first face 544 of the floating piston 534 may form one end of the third chamber 520, thereby forming one end of the liquid chamber 400, and may be in contact with the substantially incompressible fluid. An opposite second face 546 of the floating piston 534 may form one end of the compensation chamber 550 and may be in contact with a compressible fluid substantially filling the compensation chamber 550. The floating piston 534 may thereby form both a boundary of the air chamber 550 and a boundary of the substantially incompressible fluid chamber 520 and therefore form a boundary between the two chambers.

During a compression stroke, the force of the substantially incompressible fluid may increase and press against the first face 544 of the floating piston 534 and move it toward the adjuster 530 in the direction shown by the arrow 350 in FIG. 3, thereby compressing the compressible fluid in the compensation chamber 550 and increasing the pressure in the compensation chamber 550 until the force applied to the first face 544 by the substantially incompressible fluid is substantially the same as the force applied to the second face 546 by the compressible fluid. Similarly, during a rebound stroke, the force of the substantially incompressible fluid may decrease. The force applied to the second face 546 by the compressible fluid may move the floating piston 534 in a direction away from the adjuster 530 until the force applied to the second face 546 by the compressible fluid is substantially the same as the force applied to the first face 544 by the substantially incompressible fluid. When the opposing forces on the floating piston 534 are approximately equal, the floating piston 534 may either be in equilibrium or at an extreme available position.

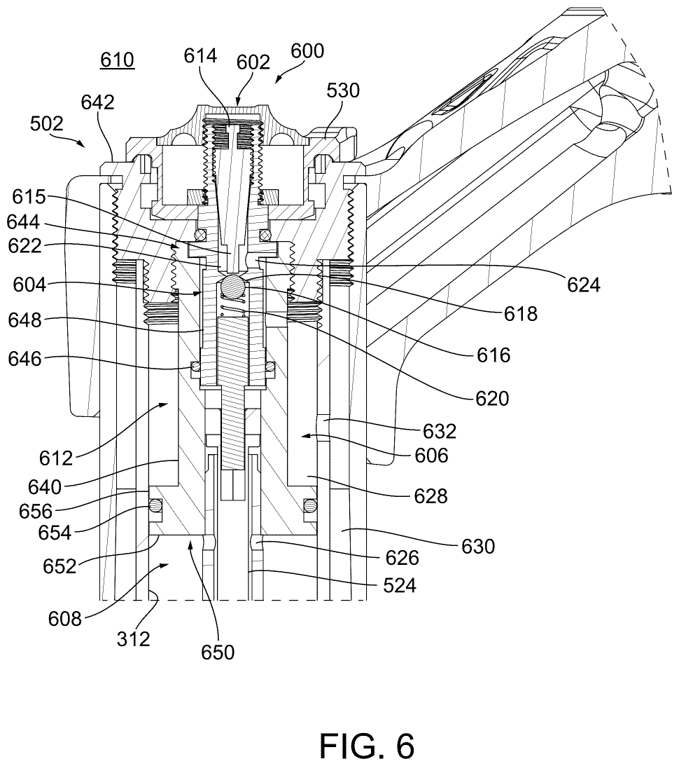

The compensator chamber 550 may be one of a first air chamber and a second air chamber that together are part of an air introduction system 600. The details of the air introduction system may be best seen in FIG. 6. The air introduction system may include a first valve 602, a second valve 604, a first air chamber 606, and a second air chamber 608, the second air chamber 608 being the compensator chamber 550 in this embodiment.

A dividing wall 640 may be attached to the upper portion 304 of the second leg 204 in any convenient manner. In the embodiment shown, the dividing wall 640 is attached to the top portion 502 of the upper leg indirectly through an intermediate member 642. The dividing wall 640 may be sealingly engaged to the first valve 602 as at 644 and by a seal 646 sealingly positioned between the dividing wall 640 and the housing 648 that in this embodiment extends from the first valve 602. The dividing wall 640 may extend radially outwardly, at a lower end 650 to be a flange 652. A seal 654 may extend around the periphery 656 of the flange 652 and sealingly engage both the flange 652 and the inner surface 312 of the upper leg 302. In this way, the dividing wall 640 and its related parts may form a portion of the boundary of a first air chamber 606 and a second air chamber 608.

The first valve 602 may extend between an exterior 610 of the second leg 204 and an interior 612 of the second leg 204. The second valve 604 may divide the air chamber into the first air chamber or first portion 606 and a second air chamber or second portion 608 when the second valve is closed. When the second valve 604 is open, the first air chamber 606 and the second air chamber 608 may comprise a single air chamber with a first portion 606 and a second portion 608.

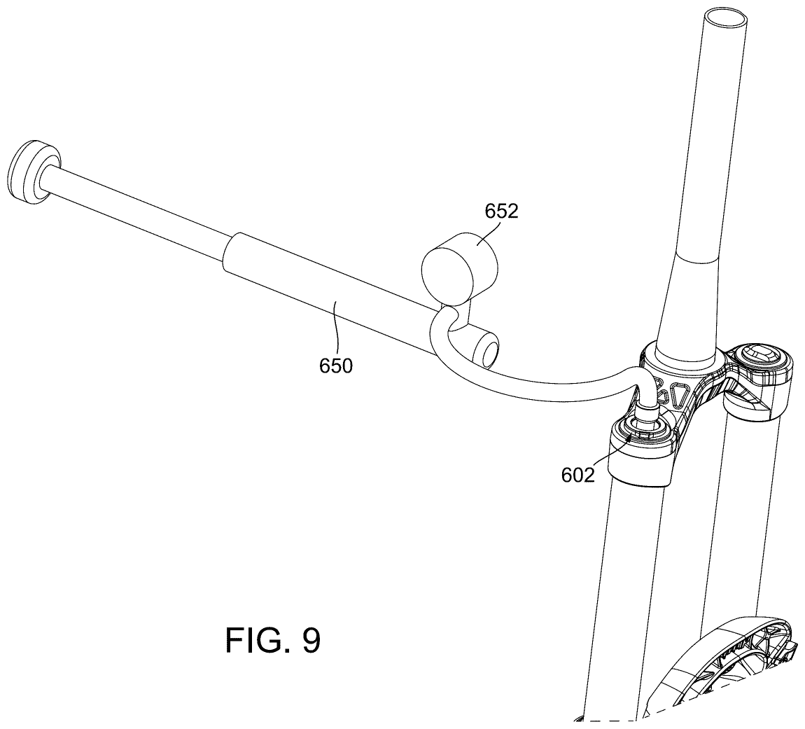

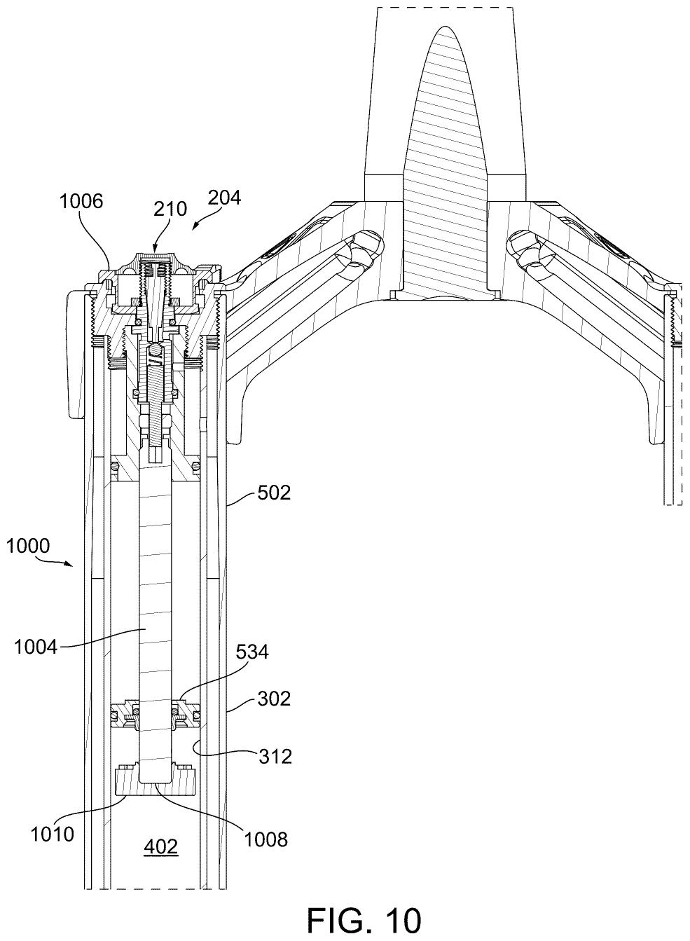

The first valve 602 may be a conventional Schrader valve. To open the first valve 602, a user may attach a conventional bike pump 650 or other manual pump to the upper end 614 of the first valve 602 in a conventional manner, as may be seen in FIG. 9. When the pump 650 is attached to the upper end 614 of the first valve 602, a finger 615 may press away from the first end 614 of the first valve and thereby move the second valve blocker or stopper 616 away from the second valve seat 618 by compressing the second valve spring 620. In this way, actuation of the first valve 602 may actuate the second valve 604. In one embodiment, the second valve spring 620 may be a light spring with a low spring force to allow the second valve 604 to also open substantially whenever the air pressure in the first air chamber 606 exceeds the air pressure in the second air chamber 608, even when the second valve 604 is not actuated by the first valve 602. When the first valve 602 is open, which thereby opens the second valve 604, a user may add or remove air from the air chambers 606 and 608 simultaneously.

The first valve 602 may be positioned in a center of, pierce through, and be attached to the rotatable adjuster 530 used to adjust the position of the pin 524 as described above. In some embodiments, the first valve 602 may be configured to be rotatable within the rotatable adjuster 530. In other embodiments, the first valve 602 may be fixed to and rotate with the rotatable adjuster 530. For most potential valves that could be used as the first valve 602, and particularly if a Schrader valve is selected, the rotational position of the first valve 602 relative to the remainder of the air introduction system 600 is unimportant. Accordingly, the specific structure for attaching the first valve 602 and the rotatable adjuster 530 may be left to the best judgment and tastes of the designer.

The volume of the first chamber 606 and the second chamber 608 may be selected such that the volume of the air in the first chamber 606 is adequate to actuate a conventional air pressure gauge 652 on the pump 650 (best seen in FIG. 9) to substantially accurately record an air pressure within the first chamber 606 upon connection. In many embodiments, it is desirable to make an accurate reading of the air pressure within the first chamber 606 upon connection, so that the rider can make an appropriate decision about what changes to make in the air pressure. A rider may use the value shown on the air pressure gauge 652 to determine how much air to add or release from the air chamber if the rider desires to adjust how the compensator chamber works.

The first chamber 606 may be configured to have a first volume and the second chamber 608 may be configured to have a second volume. When the second valve 604 is closed, the first volume of the first chamber 606 may be substantially fixed. Because one boundary of the second chamber 608 may be determined by the position of the floating piston 534, the second volume may be variable within a particular range. Because the floating piston 534 may be positioned between the second fixed piston 510 and the upper end 532 of the upper portion 304 of the second leg 204, the volume of the second chamber 608 may vary between a minimum and maximum defined by those two positions. The first volume may be greater than the second volume. In some embodiments, the first volume is at least twice the second volume.

When the first valve 602 and the second valve 604 are simultaneously opened, air from the pump 650 may be inserted simultaneously into the first chamber 606 and the second chamber 608. Air may enter from the first valve 602 into an entry chamber 622. The air may then simultaneously flow through one or more first chamber apertures 624 into the first chamber 606 and through one or more second chamber apertures 626 into the second chamber 608. In many embodiments, the first chamber 606 may include a first annular chamber 628 and a second annular chamber 630. Free passage of air between the first annular chamber 628 and the second annular chamber 630 may be provided by one or more free passage apertures 632.

If, at any time, the pressure in the first air chamber 606 exceeds the pressure in the second air chamber 608 enough to exceed the spring force on the second valve 604, the pressure in the first air chamber 606 may press against the blocker 616 and move it away from the seat 618, thereby opening the second valve 604. The second valve 604 may be a check valve. The use of a check valve may provide for one way actuation. That is, the second valve 604 may allow air to pass from the first air chamber 606 to the second air chamber 608 when the air pressure in the first air chamber 606 exceeds the air pressure in the second air chamber 608, but may serve to substantially prevent the opening of the check valve when the air pressure in the second air chamber 608 meets or exceeds the air pressure in the first air chamber 606.

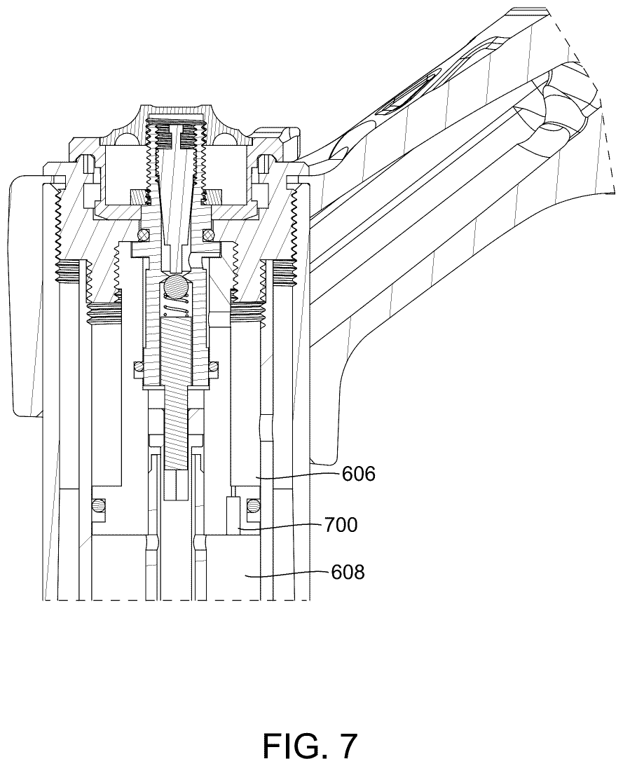

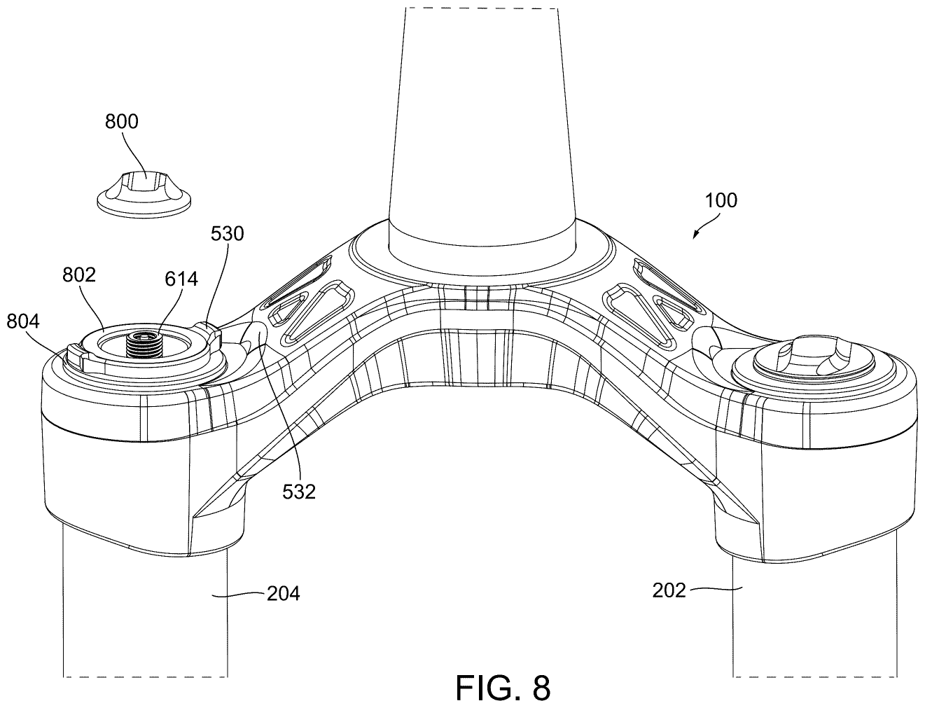

Turning now to FIG. 7, an embodiment is shown that includes an auxiliary passageway, but is otherwise unchanged from the previously disclosed embodiments. In some embodiments, it may be desirable to incorporate a very small auxiliary passageway 700 that may allow air to flow at a restricted rate from the second portion 608 to the first portion 606. That is, the auxiliary passageway 700 may restrict airflow from the second portion 608 to the first portion 606 to a rate lower than that which would be allowed if the check valve were open. In the previous embodiments the pressure in the variable volume chamber 608 may rise in a progressive manner as the suspension compresses; while the rider may alter the air pressure to change the ending resistance generated, the progressive rate of increase is unchanged. In the embodiment with the auxiliary passageway 700, the rate of progressivity of the rise of pressure during the suspension stroke is moderated relative to that of the first embodiment. Because the air may flow from the second chamber only at a restricted rate, part of the resistance generated near the end of the stroke becomes a damping force supplementary to the damping force generated by the two fixed pistons 324 and 510. This embodiment may be preferred depending on the progressivity of the primary suspension spring in the opposite fork leg 202, and other design considerations. This embodiment may also be used if a designer wishes to locate the check valve remote from the Schrader valve, such that the Schrader valve does not actuate the check valve. Although air may flow through the auxiliary passageway only at a restricted rate, this rate is sufficient to allow the two chambers to equalize in pressure in a relatively brief time period if the user wishes to lower the air pressure by means of the Schrader valve. If an auxiliary passageway 700 is provided, it may be provided in any position between the first portion 606 and the second portion 608 and it need not be located where it is shown in FIG. 7. In many embodiments, it may be desirable to position the auxiliary passageway remote from the check valve 604.

Turning now to FIG. 8, a partially exploded view of a portion of one portion of the suspension 100 is shown. In many embodiments, it may be desirable for a user to be able to enclose the Schrader valve 514 to minimize the risk that the Schrader valve 514 would be damaged and to improve the overall aesthetic appearance of the suspension 100. Accordingly, a removable cap 800 may be snap fit onto the rotatable adjuster 530 that is used for adjusting a flow characteristic of the liquid in the liquid chamber 400. In some embodiments, the removable cap 800 may be configured to fit on an inside diameter 802 of the rotatable adjuster 530 as is shown in FIG. 8. In an alternative embodiment, the removable cap 800 may be configured to fit on an outside diameter 804 of the rotatable adjuster 530. As noted, the removable cap may take any shape that is desired by the designer.

An alternative, simplified embodiment is shown in FIG. 10. In some embodiments, it may not be necessary to allow adjustment of the damping characteristics using the second fixed piston and the related structures as may be described in greater detail elsewhere in this disclosure. In such an embodiment, the compensator assembly 1000 may include a shaft 1004 attached directly or indirectly to a cap 1006, which further engages the upper portion 502 of the second leg 204. In the illustrated embodiment, the shaft 1004 is shown as being solid. However, an annular shaft could be used instead. As is shown in FIG. 10, the compensator shaft 1004 and the cap 1006 may threadably engage one another and the cap 1006 may threadably engage the second leg 204. The compensator shaft 1004 may terminate in a free end 1008. A cap 1010 may be attached at or adjacent to the free end 1008 of the compensator shaft 1004. When a cap 1010 is used, it may not extend to contact the interior surface 312 of the upper leg 302. Instead, the upper chamber 402 is bounded directly by the floating piston 534 as was described in greater detail elsewhere in this disclosure. The floating piston 534 may remain between the free end 1008 of the compensator shaft and the top end 210 of the upper leg 302, and the cap 1010 may be sized and shaped to block the floating piston 534 from falling off the free end 1008 of the compensator shaft. In such an embodiment, the chamber 520 as a separate chamber is absent and the chambers 402 and 404 alone comprise the combined liquid chamber 400

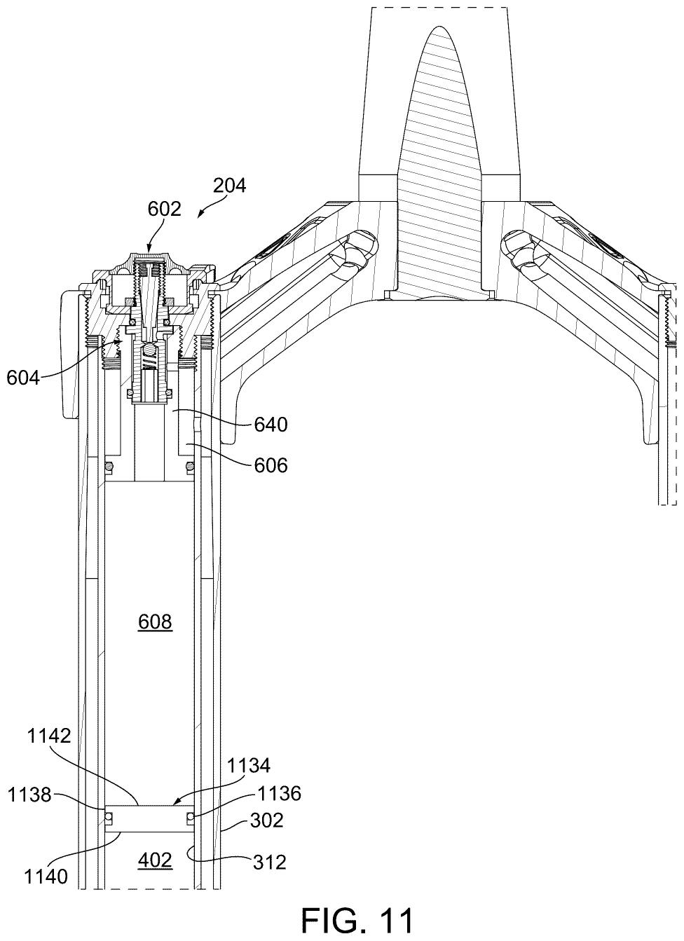

A further simplified embodiment is shown in FIG. 11. Such an embodiment by entirely omitting the compensator shaft included in the previous embodiments, along with the rotating adjuster for adjusting the pin that was enclosed in the compensator shaft, reduces the cost of manufacture of the system. In this alternative embodiment, the floating piston 1134 may simply be positioned between the upper portion 402 of the liquid chamber 400 and the second air chamber 608. A seal 1136 may be positioned on an outer periphery 1138 of the floating piston 1134. The seal 1136 may sealingly engage the floating piston 1134 and the inner wall 312 of the leg 302, thereby forming a boundary between the liquid chamber 400 and the air chamber 608. In such an embodiment, the dividing wall 640 and the second valve 604 and their related parts may have the same structure and functions as disclosed for the embodiments elsewhere in this disclosure. In the suspension stroke, the floating piston 1134 may perform the same functions as in the other embodiments by moving to equalize the forces from the liquid chamber 402 against a first side 1140 of the floating piston 1134 and the forces from the air chamber 608 against a second side 1142 of the floating piston 1134 in a manner that is conventional for compensator chambers.

This detailed description in connection with the drawings is intended principally as a description of the presently preferred embodiments of the invention and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A suspension for a vehicle, comprising:
a compensator assembly attached to a leg, comprising:
a compensator shaft attached to an end of the leg and having a free end; and
a floating piston substantially surrounding the compensator shaft and positioned between the free end of the compensator shaft and the end of the leg and defining a boundary of an air chamber; and
an air introduction system, comprising:
a first valve extending between an exterior of the leg and the interior of the air chamber; and
a second valve dividing the air chamber into a first air chamber and a second air chamber.

2. The suspension for a vehicle according to claim 1, wherein the first air chamber has a first volume, and the second air chamber has a second volume, and the first volume is larger than the second volume.

3. The suspension for a vehicle according to claim 2, wherein the first volume is at least twice as large as the second volume.

4. The suspension for a vehicle according to claim 1, wherein opening the first valve opens the second valve.

5. The suspension for a vehicle according to claim 1, wherein a rotatable adjuster is attached to the compensator shaft.

6. The suspension for a vehicle according to claim 4, wherein the second valve may open without opening the first valve.

7. The suspension for a vehicle according to claim 1, further comprising a fixed piston attached adjacent the free end of the compensator shaft.

8. A suspension for a vehicle, comprising:
an air chamber defined at least in part by a floating piston, a tube and a cap;
a check valve dividing the air chamber into a first portion and a second portion, wherein when the check valve is closed, air in the second portion is substantially prevented from flowing through the check valve to the first portion; and
an air pressure change structure comprising a Schrader valve configured to allow the attachment of a pump capable of changing the air pressure in the air chamber by changing the amount of gas present within the air chamber;
wherein a volume of the first portion is fixed and is larger than a volume of the second portion;
wherein a combined volume of the first portion and the second portion is configured to enable a pressure gauge on the pump to substantially accurately read the air pressure in the air chamber when the pump is attached to the Schrader valve; and
wherein the volume of the second portion is variable.

9. The suspension for a vehicle according to claim 8, wherein actuation of the check valve allows air to pass between the first portion and the second portion.

10. The suspension for a vehicle according to claim 8, wherein the check valve is actuated when air pressure in the first portion exceeds air pressure in the second portion enough to exceed a spring force on the check valve.

11. The suspension for a vehicle according to claim 8, wherein actuation of the Schrader valve actuates the check valve.

12. The suspension for a vehicle according to claim 8, further comprising an auxiliary passageway remote from the check valve allowing air to pass between the first portion and the second portion.

13. A suspension for a vehicle, comprising:
a first leg; and
a second leg, comprising:
a liquid chamber;
a first air chamber;
a second air chamber;
a floating piston between and separating the liquid chamber from the second air chamber, wherein a pressure from liquid in the liquid chamber is capable of moving the floating piston into the second air chamber, thereby substantially equalizing the pressure of the liquid and a pressure in the second air chamber;
an air pressure adjuster capable of adjusting the pressure in the first air chamber and the second air chamber, wherein the air pressure adjuster includes a finger that dislodges a stopper, thereby allowing air to enter the first air chamber and the second air chamber simultaneously.

14. The suspension for a vehicle according to claim 13, further comprising a rotatable adjuster for adjusting a flow characteristic of the liquid in the liquid chamber.

15. The suspension for a vehicle according to claim 14, wherein the air pressure adjuster is attached to the rotatable adjuster.

16. The suspension for a vehicle according to claim 13, wherein the air pressure adjuster comprises a Schrader valve.

17. The suspension for a vehicle according to claim 16, wherein the Schrader valve is capable of allowing air to pass from outside of the second leg into the inside of the first air chamber and capable of allowing air to pass from the inside of the first air chamber to the outside of the second leg.

18. The suspension for a vehicle according to claim 13, further comprising a damper piston within the liquid chamber attached to a shaft.

19. The suspension for a vehicle according to claim 18, wherein the shaft is attached to a rotating adjuster.

20. The suspension for a vehicle according to claim 19, wherein the floating piston substantially surrounds the shaft.
